(19) United States
(12) Patent Application Publication
(10) Pub. No.: US 2017/0034416 A1
(43) Pub. Date: Feb. 2, 2017

(54) WIRELESS CAMERA SYSTEM FOR MOBILE OPERATIONS

(71) Applicant: Appareo Systems, LLC, Fargo, ND (US)

(72) Inventors: Joseph A. Heilman, Fargo, ND (US); Barry D. Batcheller, West Fargo, ND (US); Robert V. Weinmann, Wahpeton, ND (US); Jeffrey L. Johnson, West Fargo, ND (US)

(73) Assignee: Appareo Systems, LLC, Fargo, ND (US)

(21) Appl. No.: 15/303,496

(22) PCT Filed: Apr. 9, 2015
(86) PCT No.: PCT/US15/25199

§ 371 Date: Oct. 11, 2016

Related U.S. Application Data
(60) Provisional application No. 61/977,556, filed on Apr. 9, 2014.

(51) Int. Cl. H04N 5/232; H04N 7/18; A01D 41/12

(52) U.S. Cl. CPC H04N 5/23203; A01D 41/12; H04N 5/23216; H04N 5/23293; H04N 7/181; H04N 5/23238

(57) ABSTRACT

A wireless camera system for mobile operations, comprising a mobile device, a software application, and at least one camera module, the at least one camera module comprising an image capture device, a memory, and a communications link, wherein the at least one camera module is mounted on or near a vehicle, wherein the software application is executing on the mobile device, wherein images captured by the at least one camera module may be transmitted over the communications link to the mobile device, wherein the software application processes images received from the at least one camera module, and wherein the software application displays the processed images on the screen of the mobile device.

### CROSS-REFERENCE TO RELATED APPLICATION

This application claims priority in International Patent Application No. PCT/US2015/025199, filed Apr. 9, 2015, which claims priority in U.S. Provisional Patent Application No. 61/977,556, filed Apr. 9, 2014, both of which are incorporated herein by reference.

### BACKGROUND OF THE INVENTION

1. Field of the Invention

This invention relates to the field of mobile machinery, and specifically to a wireless camera system for mobile operations.

2. Description of the Related Art

The practice of agriculture has been largely the same for many years. Advances in electronic vehicle control and sensors have allowed machines to become more efficient and for the production rate of agricultural crops to be increased dramatically. However, true advances in agriculture are not possible without veering away from these common practices and thinking in a dramatically different way.

What is needed in the art is a system for performing planting and harvesting functions which is not limited by past equipment limitations.

### SUMMARY OF THE INVENTION

This invention describes a wireless camera system for mobile operations.

One aspect of the present invention is a wireless camera system for mobile operations, comprising a mobile device, a software application, and at least one camera module, the at least one camera module comprising an image capture device, a memory, and a communications link, wherein the at least one camera module is mounted on or near a vehicle, wherein the software application is executing on the mobile device, wherein images captured by the at least one camera module may be transmitted over the communications link to the mobile device, wherein the software application processes images received from the at least one camera module, and wherein the software application displays the processed images on the screen of the mobile device.

This aspect and others are achieved by the present invention, which is described in detail in the following specification and accompanying drawings which form a part hereof

### BRIEF DESCRIPTION OF DRAWINGS

FIG. 1 is a block diagram of a wireless agricultural camera system.

FIG. 2 is an illustration of how the user can create graphics as reference marks on camera view as shown on a mobile device.

FIG. 3 is an alternate illustration of how the user can create graphics as reference marks on camera view as shown on a mobile device.

FIG. 4 is an illustration of one method for placing wireless cameras on a vehicle to obtain a 360 degree view around the vehicle.

FIG. 5 shows an illustration of how views from multiple cameras might be merged to obtain a complete 360 degree view.

### DETAILED DESCRIPTION OF THE PREFERRED EMBODIMENT

### I. Introduction, Environment, and Preferred Embodiment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof Forwardly and rearwardly are generally in reference to the direction of travel, if appropriate. Said terminology will include the words specifically mentioned, derivatives thereof and words of similar meaning.

### II. Preferred Embodiment Wireless Camera System

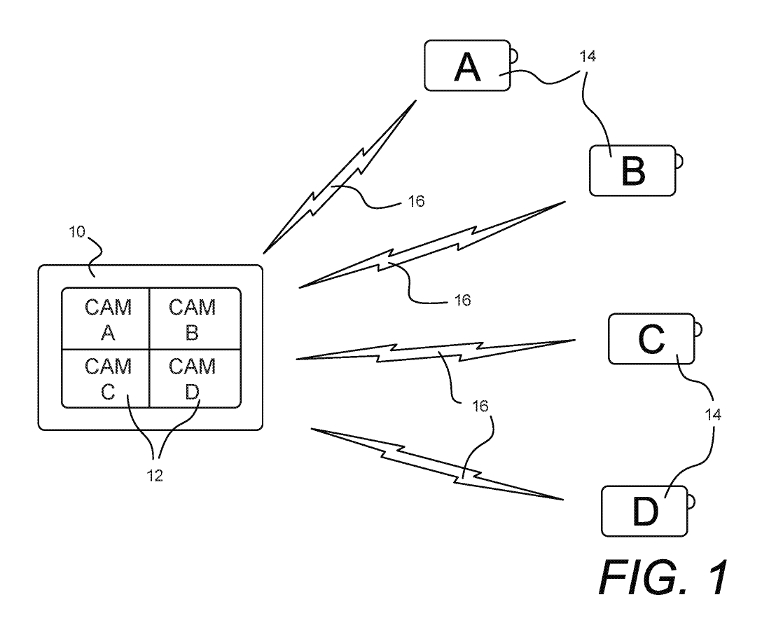

With reference now to the drawings, and in particular to FIGS. 1 through 5 thereof, a new wireless camera system for mobile applications will be discussed. FIGS. 1 through 5 relate to a system of wireless cameras which can be used to monitor operations on or around an agricultural vehicle or other mobile application. It should be noted that, although the camera system and examples shown herein relate to a camera system for use on an agricultural vehicle, the same system can be used on any type of system, whether a mobile or stationary system.

FIG. 1 shows the components of the wireless camera system. A number of wireless cameras 14 (shown in FIG. 1 as A, B, C, and D, but any number of cameras may be present in the system, from one to many) are mounted on various locations on the vehicle. Each camera 14 is placed to show a different area of the vehicle or surrounding environment of interest to the operator. These cameras 14 are self-contained, self-powered units that can be moved and adjusted as needed, and they are capable of transmitting and receiving data over a wireless connection 16. In an alternate embodiment, the cameras 14 may tie into vehicle power rather than being self-powered units. The cameras 14 may each have a built-in mounting system, which may be a clamp, a magnetic mount, a screw or bolt mount, or any other appropriate time of mounting method or mechanism.

It should be noted that the term “wireless connection” here is meant to be inclusive of any type of communication technology that does not require a hard-wired connection. This may include Bluetooth, 80211 Wi-Fi, cellular connection, or any other appropriate type of wireless protocol.

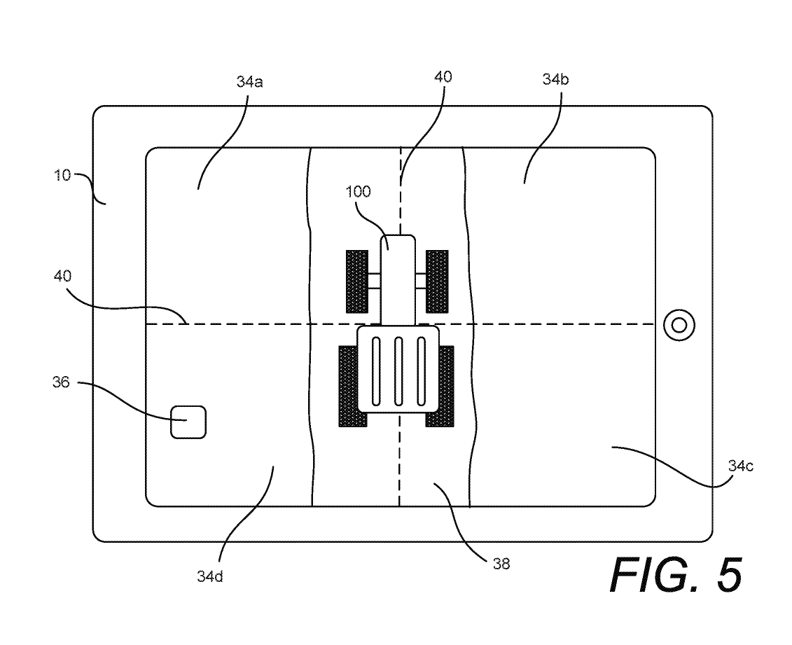

These cameras 14 transmit images to a mobile device 10 such as an iPad or similar device, and their captured video and images (camera views) 12 may be displayed on the screen of the mobile device. The view 12 from each camera 14 may be displayed on a split screen such that two or more of the views 12 are visible at once, or the operator can select a single camera view 12 to display at a given moment. Alternately, two or more camera views 12 may be “stitched together” to form a single seamless image showing more area than any single camera 14 could show independently. This stitching function will be discussed in more detail in the discussion of FIG. 5 below.

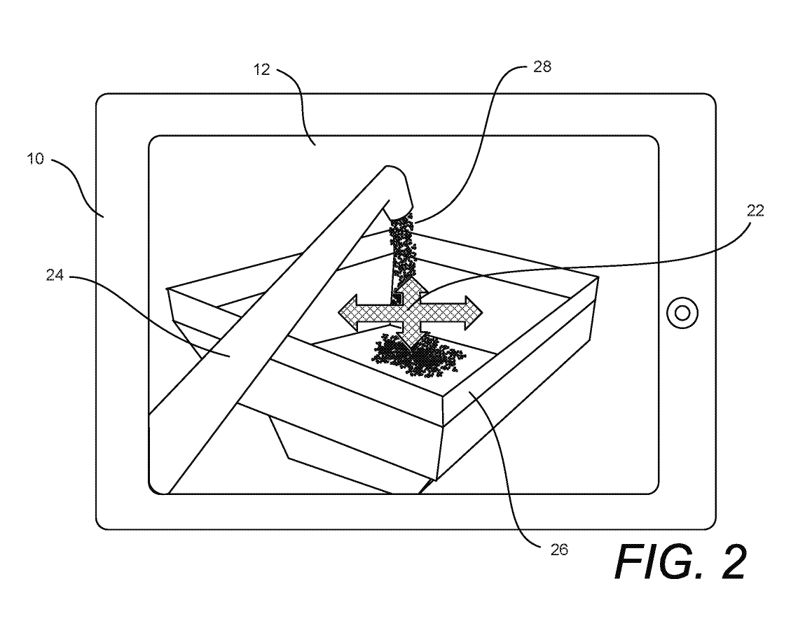

FIG. 2 is a close up view of how a user of the mobile device 10 of the present invention may interact with one or more of the camera views 12 to create reference graphics. FIG. 2 shows the mobile device 10 with alive image 12 of a grain cart 26 or a similar vehicle or application. The operator of a harvester (combine) using the wireless camera system can use the image 12 of the grain cart (in this example) so that they can properly position the unloading auger 24 of the combine properly over the grain cart 26. If the unloading auger 24 is not positioned properly, grain 28 being unloaded from the combine unloading auger 24 may spill over the side and onto the ground.

Once the operator finds a position of the combine and unloading auger 24 that works, they can interact with the mobile device view 12 and create a “reticule” or crosshairs graphic 22 that is superimposed over the view 12. This “reticule” 22 can be remembered by the application running on the mobile device 10 and can be brought up on a subsequent image of the grain cart as a reference point. That is, the reticule 22 can be displayed by the software on the mobile device 10 such that it appears in essentially the same spot on the subsequent image or view 12, and can be used as a reference for positioning for the operator of the combine during the unloading operation.

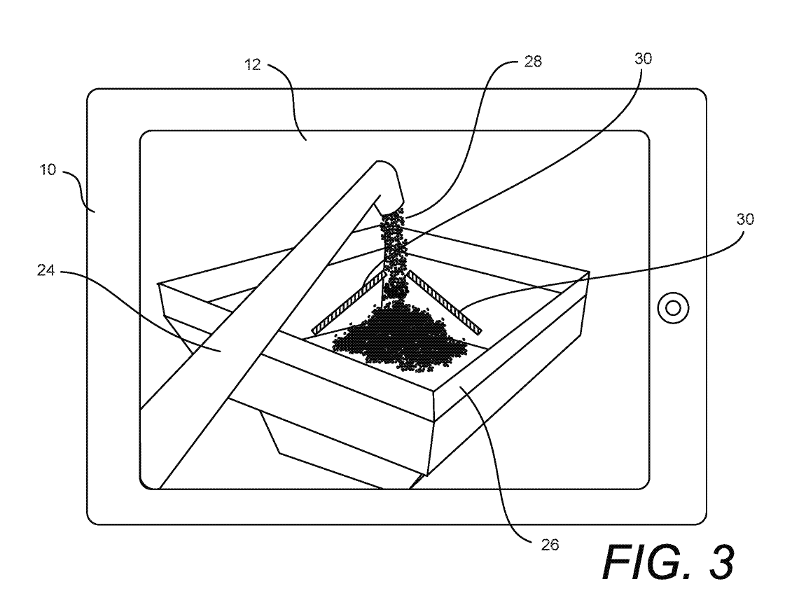

Similarly, as shown in FIG. 3, the operator can draw lines 30 or other shapes on the display to be used as references points. The example image in FIG. 3 is of the tank of a combine or grain cart 26. The straight lines 30 shown in FIG. 3 may have been drawn there by a farmer with a lot of experience in how full to fill a grain tank 26 before it needs to be unloaded. So the farmer can operate the mobile device 10 so that it displays the view 12 of the grain tank 26 and then draw slope lines 30 on the view 12 so that an inexperienced operator will know approximately when to stop by unloading the harvested grain until the slopes of the pile of grain 28 approximately matches the slope of the reference lines 30. These reference lines 30 can be saved for later display on similar views 12.

The application running on the mobile device may have intelligent software routines which remember the position of the lines 30 based on the camera angle present when the lines 30 were created, and use this information to reposition the lines 30 for later display with similar views 12. Obviously, lines 30 drawn on an image as seen from one view angle 12 will look different if you switch to an alternate view angle 12. The application may have software to compensate for this fact, perhaps searching for key indexing points on the view 12 to line up the reference lines 30, or perhaps remembering the location in space of the camera at the time the image was taken.

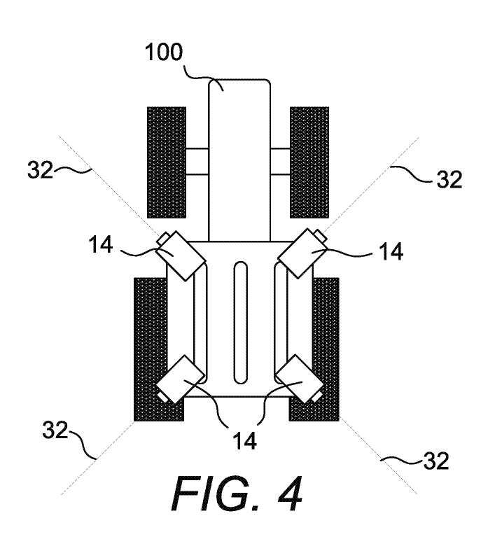

Another use of the wireless camera system of the present invention is to create a 360-degree view of the environment around the tractor or vehicle. This is shown in FIGS. 4 and 5.

FIG. 4 shows an overhead view of a typical tractor 100 with four cameras 14 mounted on the cab roof (or anywhere else on the vehicle 100, as appropriate). Each camera 14 is covering a different view of the environment around the tractor 100. More than four cameras 14, mounted in a circular pattern around the vehicle 100, could be used to capture additional detail from the environment. The dashed lines 32 in FIG. 4 are provided for reference only, showing the approximate viewing angle of each of the four wireless cameras 14 shown in this embodiment and example.

The video or images captured from these cameras could then be “stitched together” by the software application running on the mobile device 10 to create a 360-degree view, as shown in FIG. 5. The example image in FIG. 5 shows an image of a tractor 100, which may be a graphical representation of the tractor/vehicle 100 pulled from a library of models, or an actual image of a vehicle of the same style. The tractor 100 is superimposed on actual video footage that has been stitched together. That is, the imagery taken from the four cameras 14 can be processed and joined together into a larger image. Dashed lines 40 are shown on the display of the mobile device 10, showing the dividing lines between the four images. The images from each camera 14 are shown in FIGS. 5 as 34a, 34b, 34c, and 34d. Assuming the cameras 14 are positioned as shown on the tractor 100 as seen in FIG. 4, each camera 14 will capture images from one of four directions, and the images may be tweaked to make them fit together into a larger image. Because the images may overlap, an algorithm running on the mobile device 10 could use the overlapping imagery to join the images into a single larger image. The dashed lines 40 may actually be displayed on the mobile device 10 to show which image comes from which camera. The image displayed in this manner will be composed of real images, showing real-world things such as roads 38 and hazards 36.

Additional graphics routines may allow the operator to spin the view visible on the mobile device so that he or she can see a panoramic view of the environment, or to see a simulated 3D environment based on the images seen in the images.

The cameras described in the examples above are shown focused “inwardly”, that is, they show images of the tractor itself However, as these cameras are mobile and self-contained, they can be mounted to see imagery external to the vehicle. For example, a camera could be mounted on the boom of a sprayer, pointed down and slightly ahead of the spray nozzles, to allow the operator to see obstructions or humans or animals in the path of the spray.

Having described the preferred embodiments, it will become apparent that various modifications can be made without departing from the scope of the invention as defined in the accompanying claims. The examples and processes defined herein are meant to be illustrative and describe only particular embodiments of the invention.

Having thus described the invention, what is claimed as new and desired to be secured by Letters Patent is:

1. A wireless camera system for mobile operations, comprising:
a mobile device;
a software application;
at least one camera module, the at least one camera module comprising:
an image capture device;
a memory; and
a communications link; and
wherein the at least one camera module is mounted on or near a vehicle, wherein the software application is executing on the mobile device, wherein images captured by the at least one camera module may be transmitted over the communications link to the mobile device, wherein the software application processes images received from the at least one camera module, and wherein the software application displays the processed images on the screen of the mobile device.

2. The wireless camera system for mobile operations of claim 1, wherein the software application further comprises allowing the user to add graphical elements to the images displayed on the screen of the mobile device, wherein the graphical elements provide reference information for an operation of the vehicle.

3. The wireless camera system for mobile operations of claim 1, wherein the communications link is a wireless means of communication.

4. The wireless camera system for mobile operations of claim 1, wherein the communications link is a hardwired means of communication.

5. A method of aiding in the operation of a vehicle, the method comprising the steps of:
mounting at least one camera module on a vehicle, the camera module comprising:
an image capture device;
a memory; and
a communications link;
capturing images with the at least one camera module;
transmitting the images to a mobile device;
processing the images using a software application executing on the mobile device; and
presenting the images to an operator.

6. The method of aiding in the operation of a vehicle of claim 5, the method further comprising the step of:
providing a user interface to the operator, wherein the operator can use the user interface to create graphical elements on top of the presented images, wherein the graphical elements aid the operator in an operation using the vehicle.
